(19) United States
(12) Patent Application Publication
(10) Pub. No.: US 2011/0041872 A1
(43) Pub. Date: Feb. 24, 2011

(54) RAPID SUPPLY OF FLUORINE SOURCE GAS TO REMOTE PLASMA FOR CHAMBER CLEANING

(76) Inventors: Richard Allen Hogle, Oceanside, CA (US); Paul Alan Stockman, Hillsborough, NJ (US); Partick Helly, Valley Center, CA (US)

Correspondence Address: The BOC Group, Inc., 575 MOUNTAIN AVENUE, MURRAY HILL, NJ, 07974-2082, US

(21) Appl. No.: 12/867,817

(22) PCT Filed: Feb. 19, 2009
(86) PCT No.: PCT/US2009/034500

§ 371 Date: Oct. 29, 2010

Related U.S. Application Data
(60) Provisional application No. 61/030,347, filed on Feb. 21, 2008.

(51) Int. Cl. B08B 9/027

(52) U.S. Cl. 134/1.1; 156/345.1

(57) ABSTRACT

A system and method for performing rapid chamber cleaning is described. The use of F₂ as the source gas for an RPS to form fluorine radicals used in the chamber cleaning operation allows chamber cleaning to proceed at an initial rapid rate without requiring ramp up of the cleaning gas flow. This results in more rapid cleaning and significantly shorter cleaning cycles. This is useful in semiconductor manufacturing, particular, for flat panel displays and solar photo voltaic devices.

### CROSS REFERENCE TO RELATED APPLICATIONS

This application claims priority from International Application No. PCT/US2009/034500 filed Feb. 19, 2009 claiming priority from U.S. Application No. 61/030,347 filed Feb. 21, 2008.

### FIELD OF THE INVENTION

The present invention relates to the use of fluorine gas to perform chamber cleaning in a production process for flat panel displays (FPD) and photo voltaic (PV) thin films.

### BACKGROUND OF THE INVENTION

In the production of FPD and PV thin films, frequent cleaning of the deposition chambers is required. This cleaning step reduces the time available for production and therefore increases overall production costs.

A significant problem for the cleaning step relates to the speed at which the source gas can be introduced to the Remote Plasma System (RPS) for production of fluorine radicals that can be introduced to the chamber. Some fluorine source gases will extinguish the fluorine plasma in the RPS if introduced too rapidly.

A common source gas for fluorine radical production is nitrogen trifluoride (NF3). However, NF₃ exhibits the problem noted above, that the plasma is extinguished if its introduction to the RPS is too rapid or ramped up at too great a speed. U.S. Pat. No. 6,374,831 addresses this issue and establishes a limit of 1.67 scc/sec² as the maximum rate that NF₃ flow can be increased to avoid extinguishing the RPS. This means that in a practical setting the NF₃ flow can be stepped up from zero in increments of about 100 sccm every second until the full desired flow is achieved. One standard type of RPS is the Astron EX RPS that has a maximum flow of 6,000 sccm. Therefore, when using such an RPS and NF₃, the flow must be ramped up over a 60 second period. In addition, during ramp up, the cleaning rate is at less than the maximum.

U.S. Pat. No. 6,880,561 suggests the use of F₂ as the source gas, but does not use an RPS. Rather, in this patent, the chamber must be heated to greater than 450° C. for cleaning to take place. This also adds time to the process and the additional cost of a heating system.

There remains a need in the art for improvements to chamber cleaning for FPD and PV thin film manufacturing.

### SUMMARY OF THE INVENTION

The present invention overcomes the problems noted above and provides for more rapid chamber cleaning. In particular, the present invention uses a F₂ source gas along with a standard RPS, such as an Astron EX RPS, to produce fluorine radicals to perform chamber cleaning.

### BRIEF DESCRIPTION OF THE DRAWINGS

FIG. 1 is a schematic view of a system for performing chamber cleaning in accordance with the present invention.

### DETAILED DESCRIPTION OF PREFERRED EMBODIMENTS

The present invention provides a system and method for performing chamber cleaning more rapidly than has been done in the prior art. In particular, the present invention uses F₂ as the source gas for an RPS to form fluorine radicals used in the chamber cleaning operation.

By using F₂ the disadvantage of the prior art noted above can be overcome. In particular, no ramping up of the F₂ flow is required. Rather, the F₂ can be introduced to the RPS at any flow from 15% to 100%, preferably 80% to 100%, of the maximum allowed by the RPS. This means that cleaning the time to perform chamber cleaning can be significantly reduced.

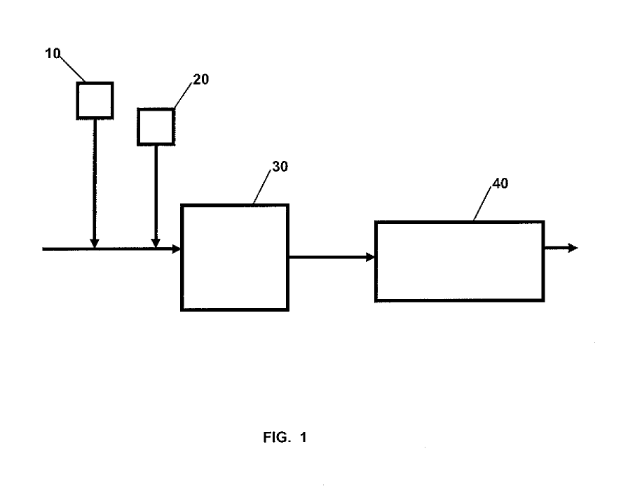

The present invention will be further described with reference to FIG. 1. Figure shows a schematic view of a system according to the present invention, wherein the system includes an argon source 10, an F₂ source 20, an RPS 30 and a chamber 40. In operation, pure argon is first introduced to the RPS at a pressure from 0.5 to 10 torr in order to establish the plasma. The argon flow is then completely shut off and F₂ is introduced to the RPS 30 up to 100% of the maximum flow allowed by the RPS 30. For example, when using a standard Astron EX RPS as noted above, the F₂ can be introduced at the full 6,000 sccm flow. No ramp up is necessary. The F₂ may be introduced at a pressure from 0.5 to 100 torr, preferable 0.5 to 3 torr. When using F₂ according to the present invention, the plasma is not extinguished and chamber cleaning time is significantly reduced.

The present invention provides several advantages over the prior art. In particular, the chamber cleaning time can be significantly reduced. In one test case, when using F₂ in accordance with the present invention, the chamber cleaning step was completed in 50 seconds, or roughly the time it would take to simply ramp up to full operation when using NF₃. By using F₂ at a higher flow rate from the outset, the cleaning can proceed at a faster rate from the beginning of the cleaning cycle and ramping up of the F₂ flow is not required. Rather, the F₂ can be introduced to the RPS at any flow from 15% to 100%, preferably 80% to 100% of the maximum allowed by the RPS.

Using the full flow of the cleaning gas at the start of the cleaning step produces a significant burst of fluorine radicals at the beginning of the cleaning cycle, resulting in a higher cleaning rate at the beginning of the cleaning cycle when the maximum amount of deposit to be cleaned is present. In addition, the presence of high radical concentration and maximum deposit to be cleaned results in an exothermic reaction that heats the deposits and increases cleaning speed. No separate heating system for the chamber is required.

The present invention also allows for optimization of the cleaning cycle. For example, the cleaning cycle can start with a very high flow and pressure for rapid material removal. However, such rapid cleaning normally exhibits poor uniformity that does not reach the corners. Then pressure can be reduced to improve uniformity. This works very well, because the corners have thinner deposits at the start of the cleaning process and therefore can be effectively cleaned after the bulk of the deposit is rapidly removed. For example, the F₂ may be introduced at a high pressure of 1-100 torr, preferably 1-50 torr at the beginning of the cleaning cycle and then reduced to 0.1 to 1 torr near the end of the cleaning cycle.

By using the present invention wherein argon starts the plasma followed immediately by a high flow of F₂ (with argon turned off), the cleaning rate can be greatly increased. This means that the time to perform chamber cleaning can be significantly reduced. Further, by providing a higher flow at the outset, the cleaning can proceed at a full rate from the beginning of the cleaning cycle. The present invention allows for use of standard existing RPS and chamber equipment without any required changes to configuration or operating parameters.

The present invention provides several advantages over the prior art. In particular, no dilution of the cleaning gas is necessary and no ramp up of the cleaning gas flow rate is required. Further, by immediately providing a high flow of the cleaning gas, the initial cleaning rate is higher and the surface being cleaned is heated to even further increase cleaning speed.

The present invention is particularly useful for cleaning chambers used in the production of flat panel and solar PV devices because of their size. However, the present invention is useful for any chamber cleaning application in the semiconductor manufacturing industry. The present invention is useful for cleaning deposits of nearly any type commonly encountered in semiconductor manufacturing, including Si, W, Ti, SiN, SiO₂, etc.

It will be understood that the embodiments described herein are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

What is claimed is:

1. A method of performing chamber cleaning comprising:
introducing argon to a remote plasma system that communicates with the chamber to be cleaned, to initiate and establish a plasma in the remote plasma system;
shutting off the flow of argon to the remote plasma system once plasma has been established;
introducing F₂ gas to the remote plasma system to form fluorine radicals; and
using the fluorine radicals to clean the chamber.

2. A method according to claim 1 wherein the argon is introduced at a pressure of 0.5 to 10 torr.

3. A method according to claim 1 wherein the F₂ gas is introduced at a flow rate of 15 to 100 percent of the maximum flow rate capability of the remote plasma system.

4. A method according to claim 3 wherein the F₂ gas is introduced at a flow rate of 80 to 100 percent of the maximum flow rate capability of the remote plasma system.

5. A method according to claim 1 wherein the F₂ gas is introduced at a flow rate of 100 percent of the maximum flow rate capability of the remote plasma system.

6. A method according to claim 1 wherein the F₂ gas is introduced at a pressure of 0.5 to 100 torr.

7. A method according to claim 1 wherein the F₂ gas is introduced at a pressure of 0.5 to 3 torr.

8. A method according to claim 1 wherein the F₂ gas is introduced at a pressure of 1 to 100 torr at the beginning of the clean cycle and gradually reduced to a pressure of 0.1 to 1 torr at the end of the clean cycle.

9. A method according to claim 1 wherein the F₂ gas is introduced at a pressure of 1 to 50 torr at the beginning of the clean cycle and gradually reduced to a pressure of 0.1 to 1 torr at the end of the clean cycle.

10. A method according to claim 1 wherein the chamber is a semiconductor processing chamber.

11. A method according to claim 10 wherein the semiconductor processing chamber is a processing chamber is used for production of flat panels or solar PV panels.

12. A method according to claim 1 wherein deposits cleaned from the chamber are at least one of Si, W, Ti, SiN or SiO₂.

13. A method of cleaning a semiconductor processing chamber using F₂ gas wherein the clean cycle is completed in less than one minute.

14. A method according to claim 13 wherein the clean cycle takes 50 seconds or less.

15. A method according to claim 13 wherein the processing chamber is used for production of flat panels or solar PV panels.

16. A method of cleaning a semiconductor processing chamber wherein source gas for producing fluorine radicals used in the clean cycle are introduced at the beginning of the clean cycle to a remote plasma system communicating with the chamber at a flow rate of 100 percent of the maximum flow rate capability of the remote plasma system.

17. A method according to claim 16 wherein the source gas is F₂ gas.

18. An apparatus for performing a chamber cleaning process comprising:
a remote plasma system in communication with the chamber to be cleaned;
an argon source communicating with the remote plasma system; and
an F₂ gas source communicating with the remote plasma system.

19. An apparatus according to claim 18 wherein the chamber is a semiconductor processing chamber.

20. An apparatus according to claim 19 wherein the chamber is used for production of flat panels or solar PV panels.
